(19) United States
(12) Patent Application Publication
(10) Pub. No.: US 2009/0302230 A1
(43) Pub. Date: Dec. 10, 2009

(54) Use of a Broad Band UV Light Source for Reducing The Mercury Interference in Ozone Measurements

(75) Inventors: John W. Birks, Boulder, CO (US); Craig J. Williford, Golden, CO (US); Peter C. Andersen, Superior, CO (US)

Correspondence Address: Oppedahl Patent Law Firm LLC (P&A), P O Box 5940, Dillon, CO, 80435-5940, US

(73) Assignee: 2B TECHNOLOGIES, INC., Boulder, CO (US)

(21) Appl. No.: 12/480,544

(22) Filed: Jun. 8, 2009

Related U.S. Application Data
(60) Provisional application No. 61/059,381, filed on Jun. 6, 2008.

(51) Int. Cl. G01J 1/42

(52) U.S. Cl. 250/373

(57) ABSTRACT

The present disclosure provides a means of greatly reducing the interference of mercury vapor in the UV absorbance measurement of ozone. Currently, commercial ozone monitors make use of a low pressure Hg lamp as the radiation source. Because the lamp spectral lines are extremely narrow and resonant with the Hg vapor absorption spectrum, ozone monitors typically detect Hg with approximately three orders of magnitude greater sensitivity than ozone itself. The replacement of the low pressure mercury lamp with a broad band UV source centered near 254 nm greatly reduces the Hg interference. The optimal band width (FWHM) for the radiation source is approximately 1-10 nm. For band widths in this range, the Hg interference is reduced by a factor of 140 (for 1 nm) to 1,400 (for 10 nm) with minimal effect on the sensitivity toward ozone and linear dynamic range. Although conventional broad band sources such as medium and high pressure Hg lamps, hydrogen lamps, deuterium lamps and xenon arc lamps could be used in conjunction with a monochromator and/or band pass filter to produce radiation of the desirable band width, recently developed UV LEDs are used in the disclosed embodiments because of their small size and low power consumption.

### CROSS REFERENCE TO RELATED APPLICATIONS

This application is a non-provisional application claiming the benefits of provisional application No. 61/059,381 filed Jun. 6, 2008.

### BACKGROUND

Ozone is a toxic gas produced in photochemical air pollution as a result of a complex sequence of reactions involving oxides of nitrogen, hydrocarbons and sunlight. The Clean Air Act in the U.S. and similar laws in other countries set limits on ozone concentrations in ambient air. Enforcement of compliance with the U.S. National Air Quality Standard requires continuous monitoring of ozone concentrations. Compliance monitoring is done almost exclusively by the method of UV absorbance of the Hg emission line at 254 nm. Low pressure mercury lamps provide an intense, stable and inexpensive source of radiation very near the maximum in the ozone absorption spectrum.

It is well known that ozone monitors based on UV absorbance suffer from interferences from other species that absorb at 254 nm. Volatile organic compounds (VOCs) that interfere are generally aromatic compounds. Some VOCs have a larger response at 254 nm than ozone itself. For example, Kleindienst et al. (1993) reported that the response of 2-methyl-4-nitrophenol is about 40% higher than ozone. Mercury provides a particularly strong interference because the electronic energy levels of Hg atoms are resonant with the Hg emission line of the low pressure Hg lamp used in ozone monitors. The relative response to Hg as compared to ozone depends on the temperature and pressure of the lamp and on the efficiency with which the instrument's internal ozone scrubber removes mercury, but is usually in the range 100-1000. The U.S. EPA (1999) reported that at a baseline ozone concentration of approximately 75 parts per billion (ppb), the action of 0.04 ppb Hg (300 ng/m³ at room temperature) caused an increase in measured ozone concentration of 12.8% at low humidity (RH=20-30%) and 6.4% at high humidity (RH=70-80%) using a UV photometric ozone monitor. For dry air, Li et al. (2006) found that 1 ppb of mercury gave a response equal to approximately 875 ppb of ozone in the same model of Thermo Electron Corporation photometric ozone monitor used in the EPA study. This mercury interference can be quite large inside buildings where mercury vapor may be present as a result of past mercury spills (broken thermometers, fluorescent light fixtures, electrical switches, etc.), near mining operations and near various industrial facilities.

Another way in which mercury interferes in the measurement of ozone using ozone photometers is by adsorption and desorption from the instrument's internal ozone scrubber. These scrubbers are typically composed of manganese dioxide, charcoal, hopcalite or heated silver wool. Mercury atoms will adsorb to and accumulate on the surfaces of the scrubber material. If the temperature of the scrubber increases, or if the humidity changes, the mercury atoms may be released from the scrubber and enter the gas stream. While removal of mercury vapor from the sample stream by the scrubber will cause a positive interference, release of mercury from the scrubber will cause a negative interference. Since mercury is present at some level in all outdoor and indoor air, this interference may be responsible for much of the baseline drift that occurs in photometric ozone monitors.

This invention provides a means of greatly reducing, typically by a factor of 100 to 1,000, the interference by Hg in ozone measurements by replacing the low pressure mercury lamp by a broad band source having a full width at half maximum (FWHM) of approximately 1 to 10 nm. A new, convenient light source having a bandwidth in this range is the UV light emitting diode (LED).

The foregoing example of the related art and limitations related therewith are intended to be illustrative and not exclusive. Other limitations of the related art will become apparent to those of skill in the art upon a reading of the specification and a study of the drawings.

### SUMMARY

One aspect of this disclosure is the measurement of ozone concentrations by UV absorbance in which a broad band UV source is used in place of the typical low pressure mercury lamp.

Another aspect of this disclosure is to use a UV-LED as a broad band light source for measurement of ozone by means of UV absorbance for the purpose of substantially eliminating the interferences of Hg and organic compounds that have strong absorption features near the Hg emission line.

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

Disclosed herein is a method for measuring ozone by UV absorbance in which the mercury atomic emission lamp is replaced by a broad band UV source. The broad band source should be significantly narrower than the UV absorbance spectrum of ozone but significantly broader than the 254-nm atomic emission line of mercury.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a schematic diagram of a typical single-beam UV absorbance instrument for measurement of ozone concentrations in air.

FIG. 2 is a schematic diagram of a typical dual bean UV absorbance instrument for measurement of ozone concentrations in air.

FIG. 3 is a plot of the absorption cross section of ozone (line 13) compared with relative intensities of 1-nm (line 11) and 10-nm (line 12) broad band sources.

FIG. 4 is a plot showing the calculated relative sensitivity of UV absorbance to ozone as a function of the band width of the emission source. Data are shown for 1 ppb ozone (line and data points 14) and 100,000 ppb (100 ppm) ozone (line and data points 15).

FIG. 4 compares the calculated mercury emission spectrum of a low-pressure Hg lamp containing a natural abundance of isotopes where the lamp pressure is 1 torr and lamp temperature is 373 K (line 16) with the calculated absorption spectrum of Hg atoms in air at ambient conditions of 760 torr and 298 K (line 17).

FIG. 6 is a plot (line 18) of the calculated relative response of a UV-absorbance instrument to Hg and O₃ in ambient air for conditions of 760 torr and 298 K as a function of source bandwidth where the source is centered at 253.652 nm.

Before explaining the disclosed embodiments of the present device in detail, it is to be understood that the concepts of the disclosure are not limited in its application to the details of the particular arrangement shown, since the disclosure is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

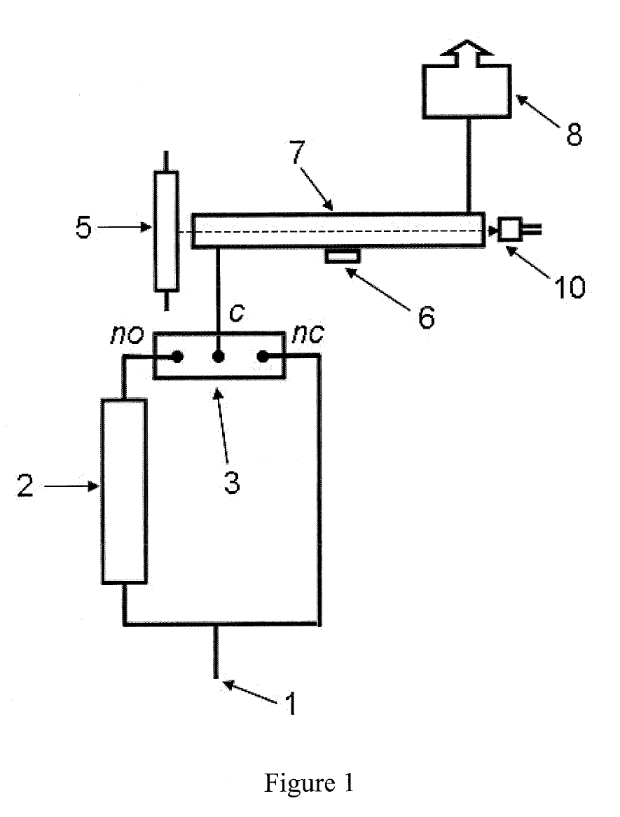

A schematic diagram of a typical single-beam UV-absorbance photometer for measuring ozone is provided as FIG. 1. Sample air flows through the instrument, entering through the inlet 1 and exiting the outlet 9. Ozone is measured based on the attenuation of light passing through a flow-through detection cell 7 fitted with quartz windows or other UV-transparent windows. A UV light source 5 is located on one side of the detection cell 7. In the prior art this would be a low-pressure mercury lamp. A photomultiplier, photodiode or other light sensing detector 10 is located on the opposite side of the detection cell 7. In the prior art an interference filter (not shown) is placed in front of the photodetector to isolate the 254 nm Hg line. Some photodiodes are made with a built-in interference filter centered at 254 nm specifically for detection using a mercury lamp. In the present disclosure the UV light source would be a broad band UV light source.

In the depicted embodiment, an air pump 8 continuously draws sample air into the instrument. In one prior art miniature ozone monitor, a fan has been used in place of the air pump (Bognar and Birks, 1996) (not shown). A solenoid valve 3 switches so as to alternately send sample air either directly through the detection cell 7 or through an ozone scrubber 2 and then through the absorption cell. The intensity of light at the photodetector 10, Iₒ, is measured for air that has passed through the ozone scrubber 2 to obtain a reference measurement of light intensity, and the attenuated light intensity, I, is measured for air that has bypassed the scrubber (I). Ozone concentration is calculated from the measurements of Iₒ and I according to the Beer-Lambert Law:

$${C}_{{O}_{3}} = \frac{1}{σ l} ln ( \frac{{I}_{o}}{I} ) \qquad ( 1 )$$

where l is the path length (typically 5-50 cm) and σ is the absorption cross section for ozone at 254 nm (1.15×10⁻¹⁷ cm² molecule⁻¹ or 308 atm⁻¹ cm⁻¹), which is known with an accuracy of approximately 1%.

The pressure and temperature within the absorption cell are measured using a pressure sensor 4 and a temperature sensor 6 so that the ozone concentration can be expressed as a mixing ratio in parts-per-billion by volume (ppbv). In principle, the measurement of ozone by UV absorption requires no external calibration; it is an absolute method. However, non-linearity of the photodiode response and electronics can result in a small measurement error. Therefore, ozone monitors are typically calibrated relative to an ozone standard such as one of the reference photometers maintained by the U.S. National Institute of Science and Technology (NIST).

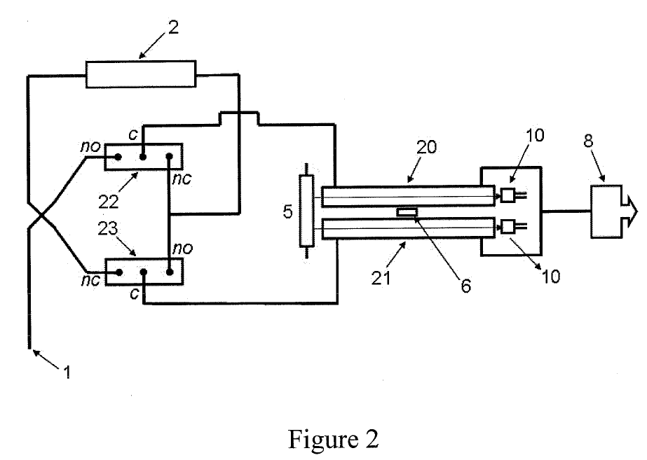

A schematic diagram of a typical dual beam instrument for ozone measurements is shown in FIG. 2. In a dual beam instrument, ozone-scrubbed air passes through one detection cell 20 to provide a reference sample to obtain a reference light intensity while sample air passes through the second detection cell 21. The flow path is periodically changed using switchable valves 22 so that I and Iₒ are alternately measured in each cell. Other than the dual detection cells, single and duel beam instruments have generally identical components. Compared to a single-beam instrument, dual beam instruments provide faster measurements than single-beam instruments, and precision may be improved due to cancellation of lamp fluctuations. Typically, dual beam instruments have better precision for the same data averaging time and better baseline stability. Other plumbing variations for dual beam ozone monitors are known; for example, rather than using parallel flow paths through the two detection cells, a single sample flow may pass through one detection cell followed by an ozone scrubber followed by the second detection cell and valves used to periodically reverse the direction of flow.

Other photometers that are used to detect ozone do not use a scrubber to obtain a reference light intensity. Instead of finding Iₒ by passing the light beam through a scrubbed air sample, there are a number of known prior art methods of obtaining an Iₒ by directing the light beam away and/or around the detection cell, taking a measurement through the interior space of the instrument to obtain a reference light intensity.

Both single beam and dual beam ozone monitors suffer from interferences from mercury and other compounds in sample air that absorb at 254 nm. The purpose of the present disclosure is to greatly reduce, often to insignificant levels, the interferences from mercury vapor and from VOCs that have strong and sharp absorption features near 254 nm in photometers used to detect ozone levels, with or without scrubbers.

In the present disclosure, the mercury lamp of the prior art is replaced by a broad band UV source. For purposes of this disclosure, a broad band source is defined as a source having a FWHM that is significantly greater than the band width of the 254-nm Hg emission line but significantly less than the band width of the absorption spectrum of ozone. Using a UV source with a FWHM much wider than the atomic emission line of Hg will greatly decrease the interference from Hg. But, in order for the Beer-Lambert Law to apply, the FWHM of the radiation source should be narrow compared to the FWHM of the ozone absorption spectrum. However, increasing the band width of the source decreases the sensitivity and linear dynamic range of the measurement. As described herein, the optimal band width for a radiation source used to measure ozone by UV absorbance is in the approximate range 1-10 nm.

Based on the calculation of a very small effect of source bandwidth on the measurement of ozone for band widths in the range 1-10 nm and calculations of large reductions in the Hg interference for the same band widths given below, it can be concluded that this is the optimal band width for ozone measurements. Smaller and larger bandwidths may be used, of course, with a corresponding trade off in sensitivity to ozone vs. level of Hg interference. The low pressure mercury lamp, widely used in commercial ozone monitors has a bandwidth on the order of 0.0001 nm; such lamps are accompanied with a very large Hg interference. Low pressure Hg lamps historically have been used because of their simple construction, intense output at 254 nm, low power requirement and low cost. Medium pressure Hg lamps, xenon arc, hydrogen, deuterium and other lamps could be used in conjunction with a band pass filter to greatly reduce the Hg interference, but at the expense of greater complexity, power consumption, etc.

Light emitting diodes (LEDs) recently have been developed with outputs in the deep UV, including wavelengths near 254 nm. These UV LEDs have band widths in the 1-10 nm range, and thus would have the advantage of reducing the Hg interference in ozone measurements. Another advantage is that UV LEDs consume less power than low pressure Hg lamps. The ozone detectors would function as described above, with the replacement of the UV LED's for the Hg lamps for the UV light source 5.

### Theory

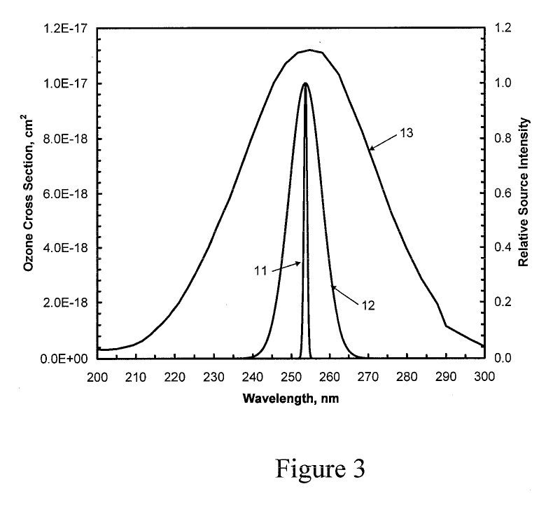

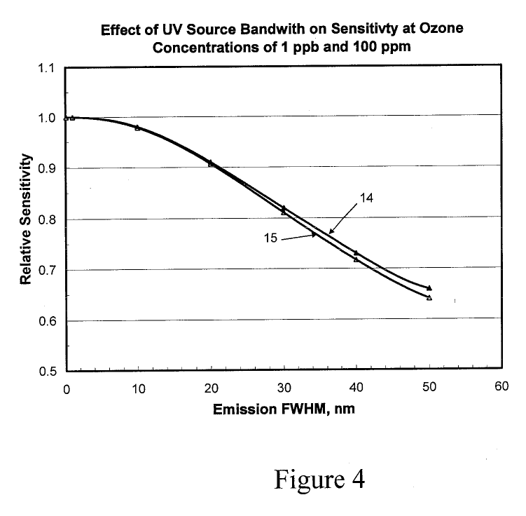

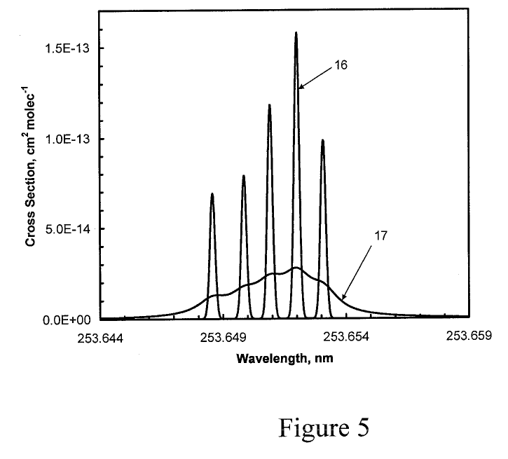

Theory may be used to estimate the effect of the bandwidth of the radiation source on ozone measurements by UV absorption and on the Hg interference in such measurements. In order to evaluate the effect of source band width on ozone measurements, calculations were made using Gaussian profiles for the source spectra,

$${I}_{o} ( λ ) = \frac{1}{σ \sqrt{2 π}} {e}^{- {( μ - λ )}^{2} / 2 {σ}^{2}} \qquad ( 2 )$$

where λ is the wavelength of light at the band center. The band width is determined by σ, which for a Gaussian profile is related to the FWHM as σ=0.424665 FWHM. The total incident light intensity Iₒ and transmitted light intensity I were computed from the integrals:

$$\begin{matrix}{I}_{o} = {\int }_{- ∞}^{∞} {I}_{o} ( λ ) d λ = 1 & ( 3 ) \\ I = {\int }_{- ∞}^{∞} {I}_{o} ( λ ) {e}^{- {σ}_{{O}_{3}} ( λ ) {C}_{{O}_{3}^{l}}} d λ & ( 4 )\end{matrix}$$

where σ_{O}_{₃}(λ) is the absorption cross section of ozone as a function of wavelength, l is the path length and C_{O}_{₃} is the true ozone concentration. The concentration of ozone that would be measured using an instrument calibrated using the mercury emission line may then be calculated for other sources by application of the Beer-Lambert Law:

$${C}_{{O}_{3}} ( measured ) = \frac{1}{{σ}_{{O}_{3} , 254} l} ln ( \frac{{I}_{o}}{I} ) \qquad ( 4 )$$

where σ_{O}_{₃}_{, 254} is the ozone absorption cross section at 253.652 nm, 1.15×10⁻¹⁷ cm² molec⁻¹. Concentrations may be converted to units of parts-per-billion (mixing ratios) by dividing by the concentration of air molecules and multiplying by 10⁹. In ozone calculations reported here, atmospheric pressure and an ambient temperature of 298 K for which the molecular concentration of air is 2.46×10¹⁹ molec cm⁻³ are assumed. FIG. 3 shows the absorption spectrum of ozone (13) and examples of Gaussian profiles for hypothetical source emission spectra having FWHMs of 1 nm (line 11) and 10 nm (12). Table 1 contains results of the calculation of the expected ozone concentration measurement as a function of true ozone concentration and source band width. FIG. 4 is a plot of the relative response to Hg and ozone as a function of source bandwidth for ozone concentrations of 1 ppb (line and data points 14) and 100,000 ppb (line and data points 15).

TABLE 1
Measured Ozone Concentration as a Function of Source Band Width and True
Ozone Concentration for Samples at 1 atm, 298 K and Path Length of 15 cm.

| Band Width, | True/Measured Ozone Concentrations | | | | | | |
|---|---|---|---|---|---|---|---|
| nm | 1 ppb | 10 ppb | 100 ppb | 1,000 ppb | 10,000 ppb | 100,000 ppb | 1,000,000 ppb |
| 0.1 | 1.00 | 10.00 | 100.0 | 1,000 | 10,000 | 100,000 | 1,000,000 |
| 1 | 1.00 | 10.00 | 100.0 | 1,000 | 10,000 | 100,000 | 999,995 |
| 5 | 1.00 | 9.96 | 99.6 | 996 | 9,959 | 99,593 | 995,775 |
| 10 | 0.98 | 9.79 | 97.9 | 979 | 9,786 | 97,837 | 975,597 |
| 20 | 0.91 | 9.10 | 91.0 | 910 | 9,095 | 90,666 | 866,945 |
| 30 | 0.82 | 8.20 | 82.0 | 820 | 8,191 | 81,087 | 698,842 |
| 40 | 0.73 | 7.32 | 73.2 | 732 | 7,306 | 71,682 | 554,079 |
| 50 | 0.66 | 6.61 | 66.1 | 660 | 6,587 | 64,108 | 459,574 |

As can be seen from Table 1, for source bandwidths of 0.1 and 1 nm, there is no significant effect on the measured ozone concentration over the range of 1 ppb to 1000,000 ppb (1000 ppm). For a source band width of 5 nm, the error is less than 0.5% at all ozone concentrations, and for a 10-nm wide source the error is in the range 2-3%. Thus, ozone measurements can be made by UV absorbance using band widths of up to 10 nm with little loss in sensitivity. Of course, any errors in measured ozone concentrations can be corrected for by calibration against a standard. With such corrections, even broader emission sources could be used, but at a sacrifice in sensitivity. From FIG. 4, it is seen that there is a slightly increased effect of bandwidth at higher ozone concentrations.

Next, the effect of using a broad band source in place of a low pressure Hg lamp on the response of Hg in ambient air can be calculated, which can act as an interference in ozone measurements. For these calculations, the Hg emission/absorption line is modeled as a function of temperature and pressure. For a lamp containing the natural isotopic abundance of mercury, the Hg emission line is actually composed of five individual lines that become resolved below about 100 torr of pressure. These lines result from hyperfine splitting of the natural isotopic mixture. The relative line positions are given by Schweitzer (1963). The lines are broadened from their natural line widths by Doppler and collisional broadening. Doppler broadening, described by a Lorentzian function, dominates at low pressures, while collisional broadening, described by a Gaussian function, dominates at high pressure. The Voigt function describes the convolution of both types of broadening. The Voigt cross section, σ_{V}, is well approximated (Whiting, 1968) by

$${σ}_{V} ( v ) = {σ}_{v} ( {v}_{o} ) [ \begin{matrix}( 1 - x ) {e}^{- ( 4 ln 2 ) {y}^{2}} + \frac{x}{1 + 4 {y}^{2}} + \\ 0.016 ( 1 - x ) x ( {e}^{- 0.4 {y}^{2.25}} - \frac{10}{10 + {y}^{2.25}} )\end{matrix} ] \\ where \\ x = \frac{Δ {v}_{coll}}{Δ {v}_{V}} \\ {σ}_{V} ( {v}_{o} ) = \frac{S}{Δ {v}_{V} ( 1.065 + 0.447 x + 0.058 {x}^{2} )} \\ y = \frac{\vert v - {v}_{o} \vert}{Δ {v}_{V}} \\ Δ {v}_{V} = 0.5346 Δ {v}_{coll} + {( 0.2166 Δ {v}_{coll}^{2} + Δ {v}_{D}^{2} )}^{1 / 2} \qquad ( 5 )$$

Here, S is the integrated cross section, Δv_{D} is the FWHM Doppler-broadened line width given by Δv_{D}=7.1×10⁷ (T/M)^{1/2}, where T is the absolute temperature and M is the molar mass in g, and Δv_{coll} is the Lorentzian line wide due to collisional broadening given by Δv_{coll}=8.996 P (273/T)^{1/2} MHz/torr, as determined by Jacobs and Warrington (1999) for Hg in nitrogen.

FIG. 5 shows the results of calculations of the Hg emission line shapes for a natural abundance isotopic mixture for typical lamp conditions (P=1 Torr, T=373 K) (line 16) and ambient air conditions (P=760 torr, 298 K) (line 17) using the above equations. In the low pressure Hg lamp, Doppler broadening dominates, while under ambient conditions collisional broadening dominates. The value of the integrated cross section, S, was chosen such that the calculated maximum cross section at standard conditions of 273 K and 760 torr with air as the broadening gas was 2.73×10⁻¹⁴ cm², as reported by Antipov et al, 2008. Using equations 2-4, the response of an ozone monitor to 1 ppb of Hg was calculated to be 1,860 ppb O₃ equivalent; i.e., ozone monitors based on UV absorbance and using low pressure Hg lamps are expected to respond up to 1,860 times greater to Hg than to ozone. This is within a factor of two of what has actually been observed for the Hg interference. This maximum level of interference would require complete scrubbing of mercury by the ozone scrubber and no loss of Hg in the inlet and internal tubing and valves. Variations in Hg losses, Hg scrubbing efficiency and line width of the Hg lamp can explain variations in the degree of interference found in different instruments.

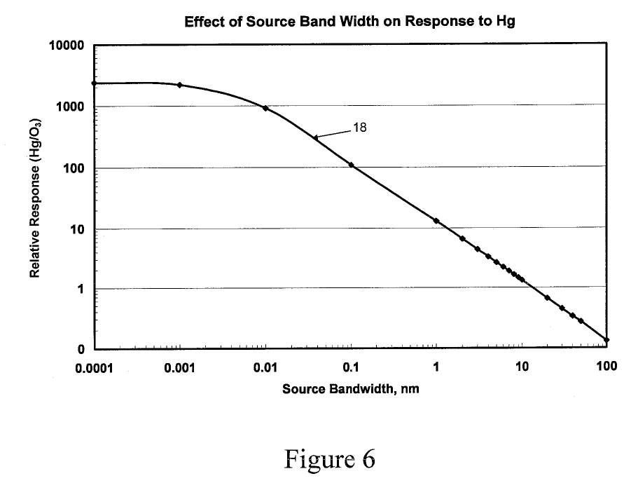

The effect of replacing the Hg lamp with a broad band source having a Gaussian shape can also be calculated. The results are summarized in Table 2 and FIG. 6 (line and data points 18).

TABLE 2
Effect of Source Bandwidth on the Relative Sensitivity of Hg and Ozone

| Source Band Width, nm | SHg/SO3 |
|---|---|
| 0.0001 | 2367 |
| 0.001 | 2187 |
| 0.01 | 919 |
| 0.1 | 109 |
| 1 | 13.1 |
| 2 | 6.62 |
| 3 | 4.42 |
| 4 | 3.32 |
| 5 | 2.65 |
| 6 | 2.21 |
| 7 | 1.90 |
| 8 | 1.66 |
| 9 | 1.47 |
| 10 | 1.33 |
| 20 | 0.66 |
| 30 | 0.44 |
| 40 | 0.33 |
| 50 | 0.27 |
| 100 | 0.13 |

The ratio of sensitivities to Hg and ozone, S_{Hg}/S_{O3}, decreases only slightly as the band width increases from 0.0001 to 0.001 nm. Once the source band width exceeds the width of the Hg absorption line, the relative response decreases approximately linearly. For a source having a FWHM of 1 nm, the response to 1 ppb Hg is equivalent to 13 ppb O₃, corresponding to a reduction in the interference by a factor of ˜140 relative to use of a low pressure Hg lamp. For a FWHM of 10 nm, the interference is reduced to 1.33 ppb, corresponding to a reduction in the interference by a factor of ˜1,400.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present device has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

In general the terms and phrases used herein have their art-recognized meaning, which can be found by reference to standard texts, journal references and contexts known to those skilled in the art. The above definitions are provided to clarify their specific use in the context of the invention.

All patents and publications mentioned in the specification are indicative of the levels of skill of those skilled in the art to which the invention pertains. All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention.

### CITED LITERATURE

Antipov, A. B., Genina, E. Yu. and Golovatskii, Y. A. (2008“Metrological Aspects of Environmental Mercury Monitoring with Atomic Absorption Analyzer,” http://www.cprm.gov.br/pgagem/Manuscripts/antipova.htm, Internal paper of the Institute for Optical Monitoring, Siberian Branch of the Russian Academy of Sciences.
Bognar, J. A. and Birks, J. W. (1996) “Miniaturized Ultraviolet Ozonesonde for Atmospheric Measurements,” Analytical Chemistry 68, 3059-3062.
Jacobs, J. P. and Warrington, R. B. (1999) “Measurement of pressure broadening and shift for Hg 254 nm line by N₂,” Bulletin of the American Physical Society 44, Part I, 729-730.
Kleindienst, T. E., Hudgens, E. E., Smith, D. F., McElroy, F. F. and Bufalini, J. J. (1993) “Comparison of Chemiluminescence and Ultraviolet Ozone Monitor Responses in the Presence of Humidity and Photochemical Pollutants, Air and Waste Management Association 43, 213-222.
Li, Y., Lee, S-R. and Wu, C-Y. (2006) “UV-absorption-based measurements of ozone and mercury: An investigation on their mutual interferences,” Aerosol and Air Quality Research 6, 418-429.
Schweitzer, Jr., W. G. (1963) “Hyperfine structure and isotope shifts in the 2537-Å line of mercury by a new interferometric method,” Journal of the Optical Society of America 53, 1055-1072.
U.S. Environmental Protection Agency (1999) Laboratory Study to Explore Potential Interferences to Air Quality Monitors, EPA-454/C-00-002.
Whiting, E. E. (1968) “An empirical approximation to the Voigt profile,” Journal of Quantitative Spectroscopy and Radiative Transfer 8, 1379-1384.

We claim:

1. A method of accurately detecting the concentration of ozone regardless of the presence of mercury vapor in a continuously flowing sample of gas, the method comprising the steps of:
providing at least one detection chamber having a broad band ultraviolet light source on one side and a light intensity detector on the opposing side;
flowing a gas sample through the detection cell;
measuring the light intensity through the gas sample in the detection cell;
measuring the light intensity in the same or a different light path and in the absence of ozone to obtain a reference intensity; and
using the Beer-Lambert Law to calculate the ozone concentration of the gas sample.

2. The method of claim 1, wherein the broad band ultraviolet source is an ultraviolet light-emitting diode (LED).

3. The method of claim 1, wherein the broad band ultraviolet source has a band width within the range of 1 to 20 nanometers.

4. The method of claim 3, wherein the band width is within the range of 1-10 nanometers.

5. The method of claim 1 further comprising the steps of:
providing a means to remove substantially all ozone in a portion of the gas sample, forming a scrubbed gas sample; and
using the scrubbed gas sample as the gas sample for the reference intensity.

6. The method of claim 1 further comprising the step of determining the pressure and temperature within the detection chamber and using the pressure and temperature with the concentration of ozone to express the ozone mixing ratio in terms of parts-per-billion by volume.

7. A method of accurately detecting the concentration of ozone regardless of the presence of mercury vapor in a continuously flowing sample of gas, the method comprising the steps of:
providing a detection chamber;
the detection chamber having a broad band ultraviolet light source on one side and a light intensity detector on the opposing side;
providing a first and second flow paths in parallel, each flowing from an atmosphere to be sampled to the detection chamber;
connecting a scrubber in the second flow path;
providing a means to direct a stream of continuously flowing sample gas into one of the two flow paths, wherein said scrubber removes ozone from said gas sample stream when it is flowing through the second flow path;
alternating which flow path the continuously flowing sample gas is flowing into;
measuring the light intensity at the detector when one of the flow paths is used;
measuring the light intensity at the detector when the remaining flow path is used; and
using a Beer-Lambert law to calculate the ozone concentration within the detection cell.

8. The method of claim 7, wherein the broad band ultraviolet source is an ultraviolet light-emitting diode (LED).

9. The method of claim 8, wherein the broad band ultraviolet source has a band width within the range of 1 to 20 nanometers.

10. The method of claim 9, wherein the band width is within the range of 1-10 nanometers.

11. The method of claim 7 further comprising the step of determining the pressure and temperature within the detection chamber and using the pressure and temperature with the concentration of ozone to express the ozone mixing ratio in terms of parts-per-billion by volume.

12. A UV-absorbance photometer for accurately detecting a concentration of ozone in a gas sample, regardless of the presence of mercury vapor, the photometer comprising:
a means to draw a gas sample into the photometer; and
a detection chamber having a broad band ultraviolet light source on one side and a light sensing detector on the opposing side functioning to detect the amount of ozone in the gas sample.

13. The apparatus of claim 12 further comprising:
a first and second flow path in parallel connecting to the detection chamber;
the second flow path having a scrubber to remove the ozone from a portion of the gas sample to form a reference gas sample;
a flow directing means functioning to direct the gas sample through the first or second flow path to the detection chamber;
the flow direction means functioning to direct the gas sample through the other flow path after a chosen amount of time;
a means to compare a value calculated by the light sensing detector when the gas sample flowed through the first flow path with a value to calculated by the light sensing detector when the gas sample flowed through the second flow path to calculate the concentration of ozone

14. The apparatus of claim 13 wherein the mixing ratio of ozone is calculated using Beer-Lambert law.

15. The apparatus of claim 12, wherein the broad band ultraviolet source is an ultraviolet light-emitting diode (LED).

16. The apparatus of claim 15, wherein the broad band ultraviolet source has a band width of 1 to 20 nanometers.

17. The apparatus of claim 16, wherein the band width is in the range 1-10 nanometers.

18. The apparatus of claim 13 further comprising a pressure sensor and a temperature sensor in contact with the detection chamber.
